(19) United States
(12) Patent Application Publication
(10) Pub. No.: US 2024/0419502 A1
(43) Pub. Date: Dec. 19, 2024

(54) ALGORITHMIC APPROACH TO HIGH AVAILABILITY, COST EFFICIENT SYSTEM DESIGN, MAINTENANCE, AND PREDICTIONS

(71) Applicant: SAP SE, Walldorf (DE)

(72) Inventors: Aby JOSE, Kottayam (IN); Uday Kumar Suresh PRABHU, Bangalore (IN); Sowmya Lakshmi R., Bangalore (IN)

(21) Appl. No.: 18/334,538

(22) Filed: Jun. 14, 2023

(51) Int. Cl. G06F 9/50

(52) U.S. Cl. CPC G06F 9/505; G06F 9/5072

(57) ABSTRACT

A cloud computing design evaluation platform may receive a master variant for a cloud computing design, including a sequential sequence of a set of components. The evaluation platform may then determine a maximum number of parallel levels for the master variant and automatically create a plurality of potential variants of the master variant by expanding the master variant with parallel components in accordance with the maximum number of parallel levels. The evaluation platform determines reliability information (e.g., based on MTBF data) and cost information (e.g., a TCO) for each component. An overall reliability score and overall cost score for each of the automatically created potential variants is automatically calculated and an evaluation result of the calculation is indicated (reflecting an optimum design that meets SLA and TCO goals). Some embodiments may also provide continuous monitoring of design performance and/or predict future design performance based on historical data.

### BACKGROUND

An enterprise, such as a business, may implement processes using a cloud computing environment. For example, a system design might couple multiple components together (e.g., a load balancer, database, and application server) for execution in a cloud computing environment to support Human Resource (“HR”) processing, Purchase Order (“PO”) activities, financial monitoring, etc. In today's cloud world, these systems include many different types of components and subcomponents (e.g., hardware, software, and network elements) that each may have different reliability and cost considerations. Moreover, a cloud service provider might have a contractual Service Level Agreement (“SLA”) with customers having certain system reliability goals. For example, a cloud service provider might offer high reliability or availability to certain customers (e.g., a service provider could offer 99.x % reliability to some customers). It is possible to improve component reliability by replicating components in a parallel fashion. Such an approach, however, may increase the costs associated with a system design. Currently, there is no automated model that accurately helps a service provider understand the components and subcomponents that may require replication to derive an optimal architecture design. Instead, more often, the provider manually selects elements to replicate adding additional, and perhaps unnecessary, cost.

Currently, SLA promises are to customer “one size fits all.” For example, in some cases a service provider may be forced to offer a static SLA to all customers because it doesn't have the flexibility to add/remove replications dynamically in view of reliability impact. All customers might not require substantially high reliability (e.g., 99.99%), and it would provide more flexibility to service providers if they could offer different packages to customers based on criticality. For example, the provider might want to charge more to a customer who prefers 99.9% reliability as compared to a customer who is comfortable with 99.5% reliability. This type of flexible approach might provide benefits for both the cloud customer (e.g., a desired SLA at a reasonable price) and the service provider (e.g., cost savings)—but may not be practical without a way of automatically and accurately evaluating potential system designs.

Systems are desired that facilitate an accurate and efficient algorithmic approach to high availability, cost efficient system design, maintenance, and predictions in a cloud computing environment.

### SUMMARY

According to some embodiments, methods and systems may include a cloud computing design evaluation platform that receives a master variant for a cloud computing design, including a sequential sequence of a set of components. The evaluation platform may then determine a maximum number of parallel levels for the master variant and automatically create a plurality of potential variants of the master variant by expanding the master variant with parallel components in accordance with the maximum number of parallel levels. The evaluation platform determines reliability information (e.g., based on MTBF) and cost information (e.g., a TCO) for each of the set of components. An overall reliability score and overall cost score for each of the automatically created potential variants is automatically calculated and an evaluation result of the calculation is indicated. The final result may represent the most optimally designed architecture of components and subcomponents that satisfies the needs of both the service provider and the consumer. Some embodiments may also provide continuous monitoring of design performance and/or predict future design performance based on historical data.

Some embodiments comprise: means for receiving, by a computer processor of a cloud computing design evaluation platform, a master variant for a cloud computing design, including a sequential sequence of a set of components; means for determining a maximum number of parallel levels for the master variant; means for automatically creating a plurality of potential variants of the master variant by expanding the master variant with parallel components in accordance with the maximum number of parallel levels; determining reliability information for each of the set of components; determining cost information for each of the set of components; automatically calculating an overall reliability score and overall cost score for each of the automatically created potential variants; and indicating an evaluation result of said calculation.

Some technical advantages of some embodiments disclosed herein are improved systems and methods providing accurate and efficient algorithmic approach to high availability, cost efficient system design, maintenance, and predictions in a cloud computing environment.

### BRIEF DESCRIPTION OF THE DRAWINGS

FIG. 1 is a high-level block diagram of a design evaluation system in accordance with some embodiments.

FIG. 2 is a design evaluation method according to some embodiments.

FIG. 3 is a reliability algorithm in accordance with some embodiments.

FIGS. 4A and 4B are cloud computing designs according to some embodiments.

FIG. 5 is a system in accordance with some embodiments.

FIG. 6 is a system with parallel components according to some embodiments.

FIG. 7 is another system with parallel components in accordance with some embodiments.

FIG. 8 is a process flow for a proposed algorithm according to some embodiments.

FIG. 9 illustrates potential variants in accordance with some embodiments.

FIG. 10 is pseudocode to identify the reliability of each variant according to some embodiments.

FIG. 11 is pseudocode to identify TCO for each variant in accordance with some embodiments.

FIG. 12 is pseudocode to select a variant according to some embodiments.

FIG. 13 is a machine learning process flow to predict a future design in accordance with some embodiments.

FIG. 14 is a high-level machine learning system architecture according to some embodiments.

FIG. 15 is an overall evaluation process in accordance with some embodiments.

FIG. 16 is a reliability score display according to some embodiments.

FIG. 17 is a design solution display on a tablet computer in accordance with some embodiments.

FIG. 18 is another design solution display according to some embodiments.

FIG. 19 is a smartphone optimal solution user interface in accordance with some embodiments.

FIG. 20 is an evaluation result display according to some embodiments.

FIG. 21 is an apparatus in accordance with some embodiments.

FIG. 22 is a portion of a tabular design evaluation data store according to some embodiments.

### DETAILED DESCRIPTION

Briefly, some embodiments facilitate an accurate and efficient algorithmic approach to high availability, cost efficient system design, maintenance, and predictions in a cloud computing environment. In the following detailed description, numerous specific details are set forth in order to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

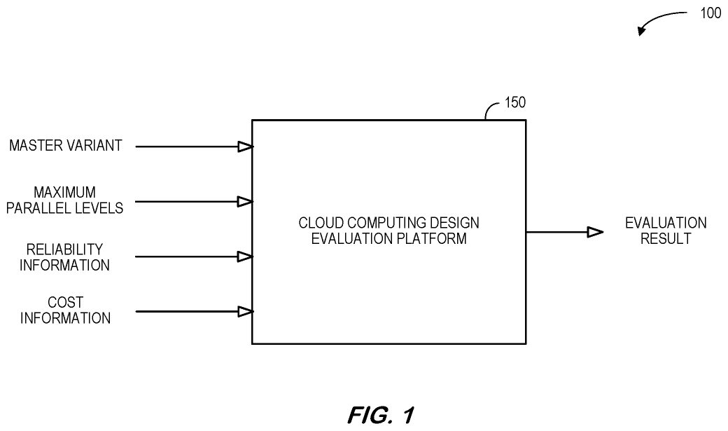

FIG. 1 is a high-level block diagram of a system 100 in accordance with some embodiments. The system 100 includes a cloud computing design evaluation platform 150 that receives various inputs (e.g., a master variant system design, a maximum number of parallel levels, reliability information, cost information, etc.). According to some embodiments, devices, including those associated with the system 100 and any other device described herein, may exchange data via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 100 may store data into and/or retrieve data from various data stores (e.g., a component database or a historical reliability data store), which may be locally stored or reside remote from the cloud computing design evaluation platform 150. Although a single cloud computing design evaluation platform 150 is shown in FIG. 1, any number of such devices may be included. Moreover, various devices described herein might be combined according to embodiments of the present invention. For example, in some embodiments, the cloud computing design evaluation platform 150 and machine learning engine might comprise a single component or apparatus. Some or all of the system 100 functions may be performed by a constellation of networked apparatuses, such as in a distributed processing or cloud-based architecture.

An operator (e.g., a service provider administrator) may access the system 100 via a remote device (e.g., a Personal Computer (“PC”), tablet, or smartphone) to view data about and/or manage operational data in accordance with any of the embodiments described herein. In some cases, an interactive graphical user interface display may let an operator or administrator define and/or adjust certain parameters (e.g., to define component relationships and enter information about a SLA) and/or provide or receive automatically generated recommendations, results, and/or alerts from the system 100. For example, the cloud computing evaluation platform may output an evaluation result (e.g., recommending a particular component arrangement) via an operator or administrator display.

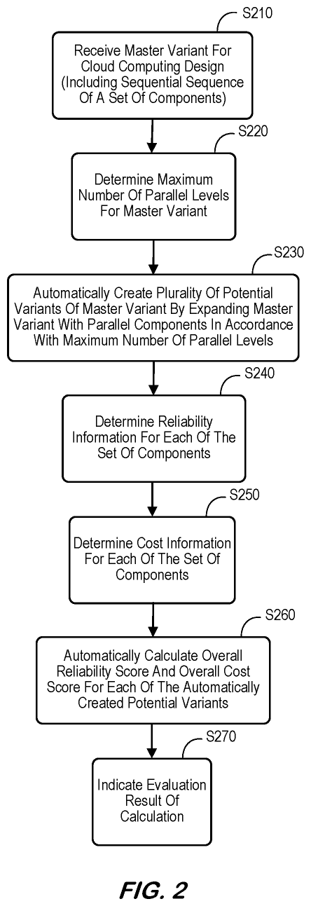

FIG. 2 is a more detailed integration method according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a computer processor of a cloud computing design evaluation platform may receive a master variant for a cloud computing design. The master variant may, for example, include a sequential sequence of a set of components. By way of examples only, a component might be associated with a load balancer, a dispatcher, a database, an application server, a file system, a router, memory, Network Address Translation (“NAT”), a messaging queue, etc. At S220, the system may determine a maximum number of parallel levels for the master variant (e.g., each component might be allowed to be replicated in parallel up to three times).

A plurality of potential variants of the master variant may then be automatically created at S230 by expanding the master variant with parallel components in accordance with the maximum number of parallel levels. The potential variants of the master variant might be created, for example by expanding the master variant with parallel identical components (e.g., two identical database components might be provided in parallel to improve reliability). According to some embodiments, at least one potential variant of the master variant is created by expanding the master variant with a parallel alternate component.

At S240, the system may determine reliability information for each of the set of components. The reliability information might be associated with, for example, a Mean Time Between Failure (“MTBF”) for each component (e.g., in days). Similarly, the system may determine cost information for each of the set of components at S250. The cost information might be associated with, for example, a Total Cost of Ownership (“TCO”) for each component. The TCO might be associated with a monetary value, an amount of computing resources, an amount of memory, Input Output (“IO”) considerations, etc. An overall reliability score and overall cost score are automatically calculated at S260 for each of the automatically created potential variants. At S270, the system may indicate an evaluation result of this calculation (e.g., to recommend one particular variant as the optimal configuration).

According to some embodiments, the cloud computing design evaluation platform is further to determine a SLA associated with the cloud computing design and the evaluation result comprises a selection of one of the automatically created potential variants based on the SLA, the overall reliability scores, and the overall cost scores. In other cases, a TCO goal might be input and used to generate the variant that meets that goal while providing the highest level of reliability.

According to some embodiments, the cloud computing design evaluation platform continuously monitors the cloud computing design in real time based on design performance. Moreover, the cloud computing design evaluation platform may, in some embodiments, use a machine learning model to predict future cloud computing design performance based on historical cloud computing design performance. In this case, the cloud computing design evaluation platform could automatically generate a recommended design based on the predicted future cloud computing design performance.

In this way, embodiments may help maintain a desirable balance between reliability and TCO for complex cloud computing environment architectures. For example, the algorithms described herein may let a provider design an optimal system architecture by suggesting the parallel replications required for various components (which in-turn can help fulfill a contractual reliability SLA agreement while keeping the TCO to a minimum value). Embodiments may also maintain a system architecture by continuously monitoring the component reliabilities (and generate an alert if the system reliability drops or is about to drop below a contractual SLA). For example, the system may automatically identify and propose a new system architecture which meets the reliability criteria while keeping the TCO down. Some embodiments may also predict the best future system architecture with the help of a time series based machine learning model. The model may, for example, analyze historical component reliabilities, observe the trends, and suggest the best design accordingly.

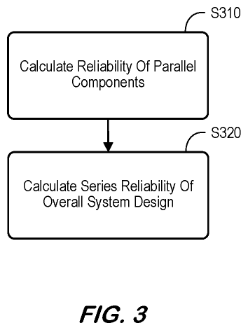

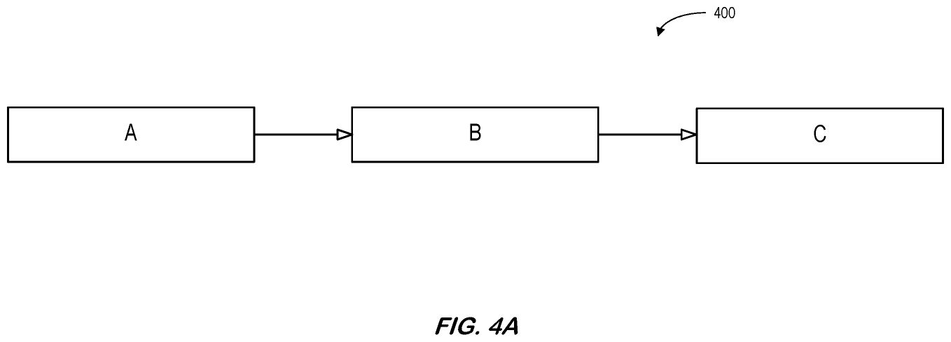

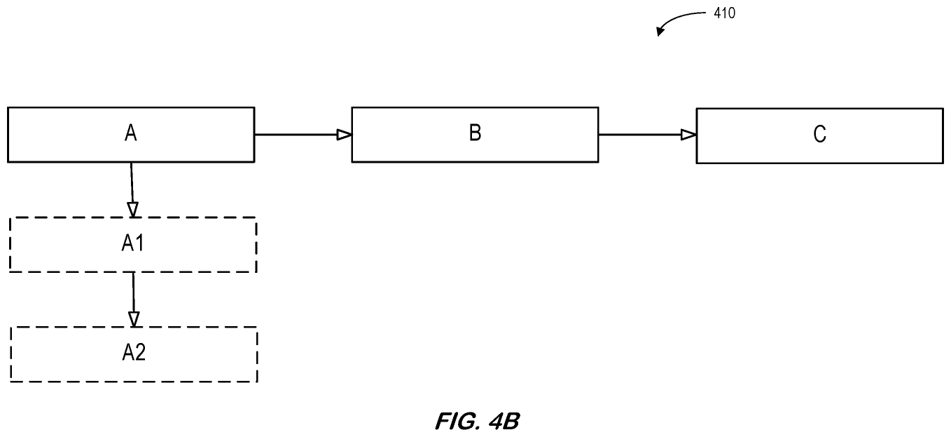

Embodiments described herein may calculate the reliability of various system designs. For example, FIG. 3 is a reliability algorithm in accordance with some embodiments. A design may consist of series and parallel components. The reliability of parallel components may be calculated first at S310 and then be used to identify the series reliability of the overall system design at S320. For example, FIGS. 4A and 4B are cloud computing designs 400, 410 in accordance with some embodiments. The first design 400 includes three components (A, B, and C) connected in series (A→B→C). Reliability may be defined as the probability that a product, system, or service will perform its intended function adequately for a specified period or will operate in a defined environment without failure. Reliability may be proportional to a failure count and MTBF of the components or systems:

$$Reliability = 1 - Failure Rate$$

$$Failure Rate = \frac{1}{M T B F}$$

Large systems may consist of various components connected in series and parallel modes. The resultant reliability of the system may be measured by calculating the relevant series and parallel reliabilities. In series-parallel structure, the system consists of subsystems in series where, for each subsystem, multiple components are used in parallel. In the first design 400 of FIG. 4A, the components A, B, and C are connected serially. Hence, the resultant system reliability is Rₐ*R_{b}*R_{c} (where Rₐ is the reliability of component A, R_{b} is the reliability of component B, and R_{c} is the reliability of component C).

A provider may replicate components parallelly to improve reliability. Hence, a single component failure will not cause the entire system to fail. The reliability of component A in the design 400 is improved in FIG. 4B, which is a cloud computing design 410 with parallel components according to some embodiments. In this case, component A is replicated twice in parallel (via A1 and A2 as showed by dashed lines in the design 410). For this architecture, the resultant reliability is:

$$\{ ParallelReliability ( A ) \} * Reliability ( B ) * Reliability ( C )$$

Since component A consists of parallel connections, the Parallel Reliability (A) is calculated first:

$$ParallelReliability ( A ) = 1 - [ 1 - Ra ] * [ 1 - R {a}_{1} ] * [ 1 - R {a}_{2} ]$$

where Ra, Ra1, and Ra2 are the respective reliabilities of components A, A1, and A2.

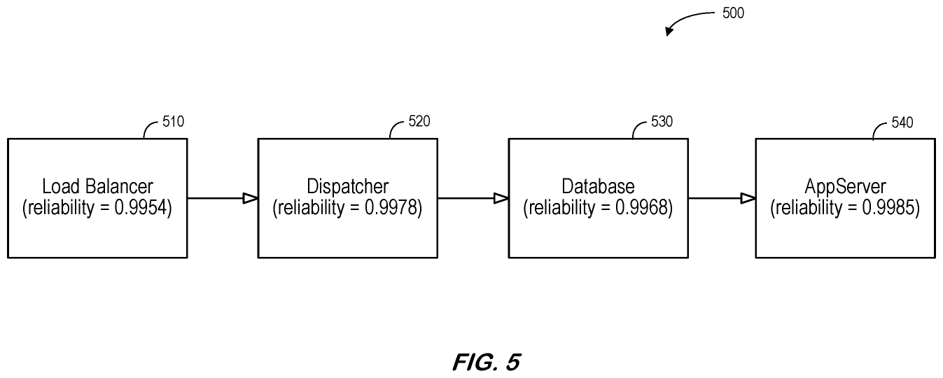

FIG. 5 is a system 500 in accordance with some embodiments. The system 500 includes a load balancer 510, a dispatcher 520, a database 530, and an application server 540 connected in series. As a result, the resultant reliability is:

$$R ( Load Balancer ) * R ( Dispatcher ) * R ( Database ) * R ( Application Server ) = 0.9954 * 0.9978 * 0.9968 * 0.9 \; 985 = 0.9885$$

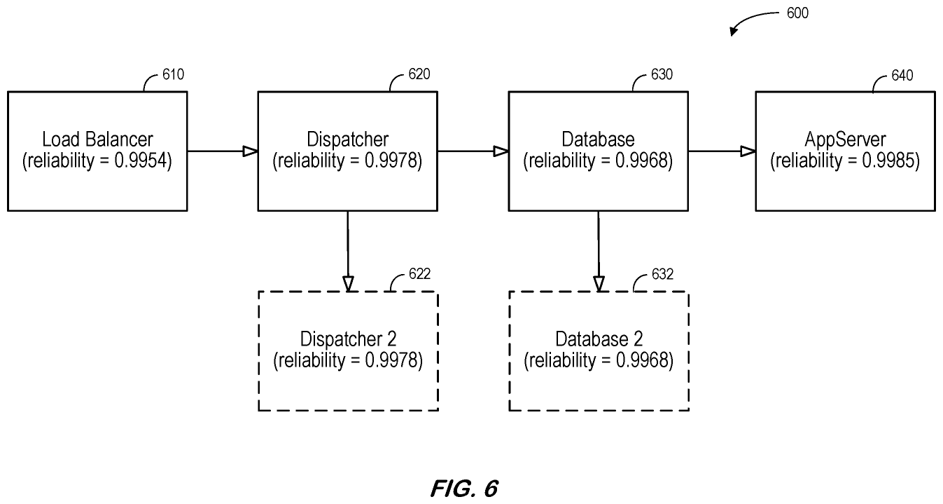

A provider could improve the system 500 reliability by adding parallel components, such as parallel components for the dispatcher 520 and database 530. FIG. 6 is a system 600 with parallel components according to some embodiments. The system 600 includes a load balancer 610, a dispatcher 620, a database 630, and an application server 640 connected in series. In addition, a second dispatcher 622 is added in parallel to the dispatcher 620 and a second database 632 is added in parallel to the database 630. As a result, the resultant reliability is:

$$R ( Load Balancer ) * R ( Parallel Reliability : Dispatcher ) * R ( Parallel Reliability : Database ) * R ( Application Server ) = 0.9954 * ( 1 - [ 1 - 0.9978 ] * [ 1 - . 9978 ] ) * ( 1 - [ 1 - 0.9968 ] * [ 1 - 0.9968 ] ) * 0.9 \; 985 = 0.9954 * 0.9999 * 0.9999 * 0.9 \; 985 = 0.9937$$

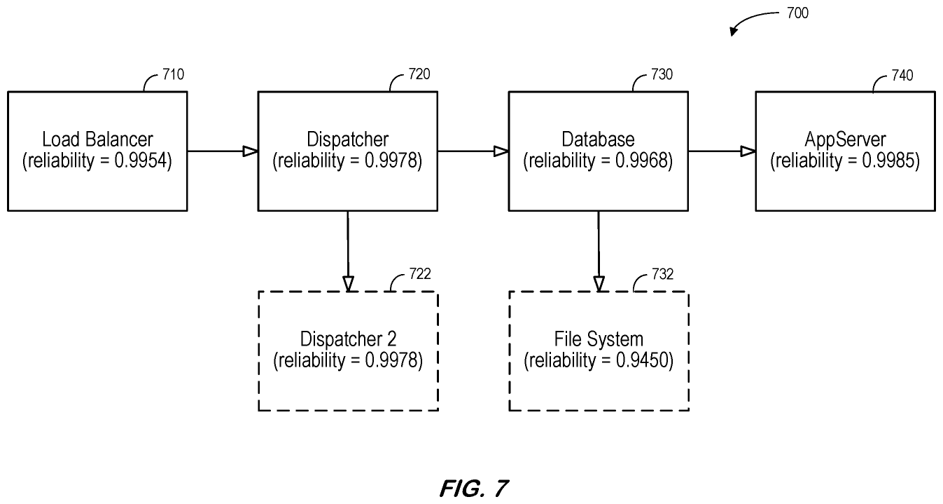

Note that in some embodiments, it is not necessary to replicate the exact same component in a parallel connection. For example, instead of using the second database 632 as a parallel connection, it is possible to use a file system as a back-up component as shown in FIG. 7, which is another system 700 with parallel components in accordance with some embodiments. As before, the system 700 includes a load balancer 710, a dispatcher 720, a database 730, and an application server 740 connected in series. In addition, a second dispatcher 722 is added in parallel to the dispatcher 720 and a file system 732 is added in parallel to the database 730. As a result, the resultant reliability is:

$$R ( Load Balancer ) * R ( Parallel Reliability : Dispatcher ) * R ( Parallel Reliability : Database + File System ) * R ( Application Server ) = 0.9954 * ( 1 - [ 1 - 0.9978 ] * [ 1 - . 9978 ] ) * ( 1 - [ 1 - 0.9968 ] * [ 1 - 0.945 ] ) * 0.9 \; 985 = 0.9954 * 0.9999 * 0.9998 * 0.9 \; 985 = 0.9936$$

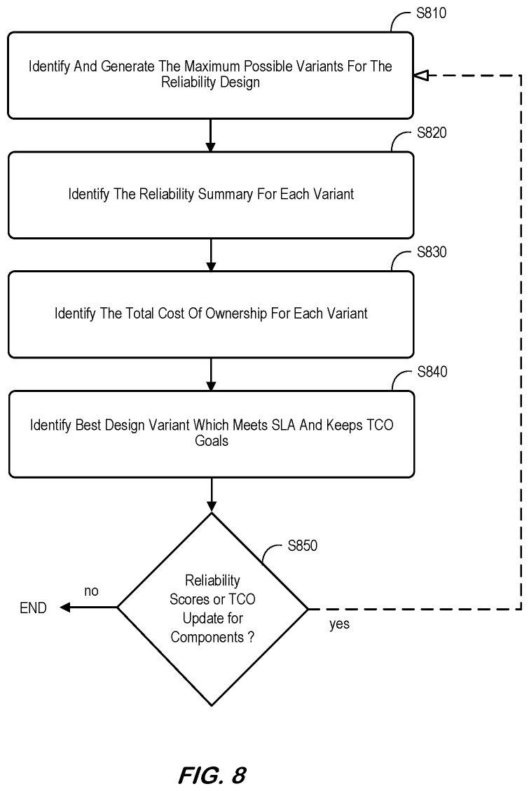

FIG. 8 is a process flow for a proposed algorithm according to some embodiments. The process flow may include several inputs. For example, reliability scores for components may be calculated with the help of failure counts and used as an input to the process flow:

$$M T B F = \frac{number of operational hours}{number of failures}$$

$$Failure Rate = \frac{1}{M T B F}$$

$$Reliability = 1 - Failure Rate$$

The reliability of components may be measured separately and provided as an input to the algorithm. Note that, by default, the same component might be considered for parallel replication using the same reliability score. If the back-up component is different or the reliability score is different, the system may need to provide the additional failure information separately. Similarly, the TCO may also be calculated per component and be supplied as an input to the algorithm. Note that, by default, the same component might be considered for parallel replication having the same TCO value. If the back-up component is different or the TCO value is different, the system may need to provide the additional cost information separately.

A reliability SLA agreed to with a customer may also be provided as an input to the algorithm. This may represent a minimum reliability that is expected from the whole system. The sequential order of components can also be supplied as a {master variant} input to the system. A maximum number of allowed parallel levels may represent an optional input parameter that indicates the maximum allowed replications (parallel connections) for components. This parameter may reduce false positives while determining the best scenario variant (by preventing endless parallelization of components).

At S810, the system may automatically identify and generate the possible variants for a reliability design. This step may, for example, identify all possible variants of a given {master variant} (the one in which the required components get arranged sequentially). The algorithm starts with master variant and expands the nodes one-by-one. At each step the variant expands one node, becoming a new variant. This process is repeated until no further expansions are possible (that is, all of the components get expanded until the maximum allowed parallel level is reached).

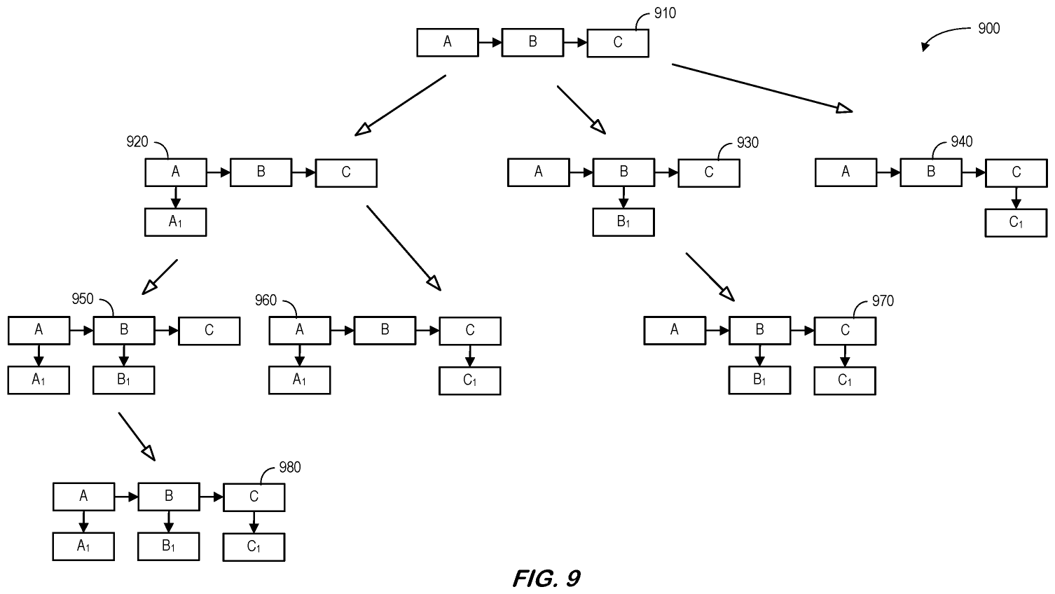

FIG. 9 illustrates potential variants 900 in accordance with some embodiments. As defined by a master variant 910, A, B, and C are components connected serially forming the system design: {master variant}=A→B→C. In this example, the maximum number of allowed replications (L) is 2. The algorithm then expands nodes and identifies new variants recursively. That is, the master variant 910 is initially expanded as follows: parallel component A₁ is added to form variant 920; parallel component B₁ is added to form variant 930; and parallel component C₁ is added to form variant 940. Further, variant 950 and variant 960 are formed by expanding variant 940 one node at a time. Since L (the maximum number of allowed possible replications) is 2, the system cannot A₁ further into A₂ (because A→A₁ already has 2 levels). Variant 970 is formed by expanding variant 930 (any other options were already identified from variant 920). Finally, variant 980 is achieved by expanding variant 950 in the only way possible (adding C₁). As can be seen, the total number of possible variants for a scenario is n^{m}, where n is the number of parallel levels and m is the number of of nodes. For the example of FIG. 9, the total number of possible variants is 2³=8. If the system instead had 4 nodes (e.g., A→B→C→D) and the maximum possible parallel levels (L) was 3, then the total number of possible variants would be 3⁴=81.

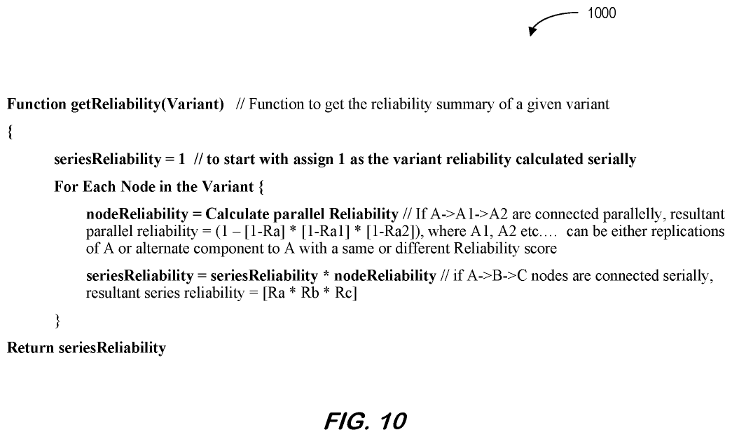

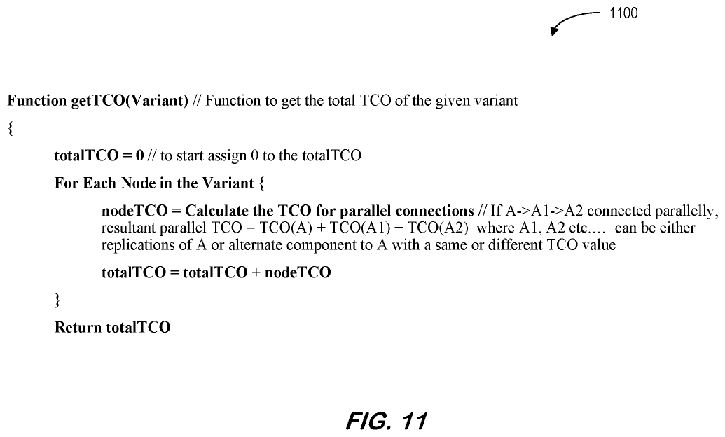

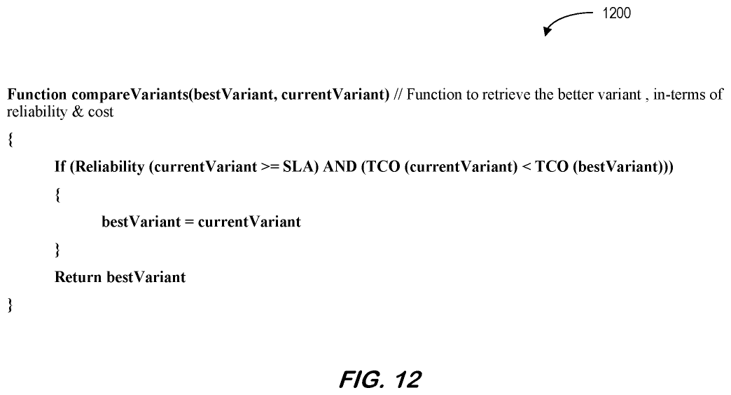

Referring again to FIG. 8, at S820 the algorithm may identify the reliability summary of each variant. That is, the resultant reliability of each variant (identified in S810) may be calculated. Each variant consists of series and parallel components. The reliability of parallel components is calculated first and then used to identify the series reliability of the system (or resultant reliability of the variant). FIG. 10 is pseudocode 1000 that might be used to identify the reliability of each variant according to some embodiments. Referring again to FIG. 8, at S830 the system may identify the TCO for each variants identified at S810. Note that the TCO of components may be supplied as an input and this step calculates the total TCO of variants (which consists of subcomponents arranged in series and in parallel). FIG. 11 is pseudocode 1100 to identify TCO for each variant in accordance with some embodiments. Referring again to FIG. 8, at S840 the system may identify the best variant based on the reliability and TCO parameters. For example, the best variant may be the one that meets the SLA while still keeping the TCO as low as possible. FIG. 12 is pseudocode 1200 to select a variant according to some embodiments.

The system may then perform continuous monitoring of reliability and TCO for a design. Referring again to FIG. 8, at S850 if there are no updates for component reliability scores or TCO, no further action needs to be performed. If, however, there are updates at S850 the process flow may be repeated (as illustrated by the dashed arrow in FIG. 8). In this way, the system may be designed to perform dynamically resulting in a new set of variants and, potentially, a new best design scenario (based on the updated reliability and TCO scores). As a result, systems are not designed just once but are instead monitored continuously (and new optimum designs can be automatically suggested based on any changes). Moreover, alerts may be triggered if the total reliability drops below (or is about to drop below) the SLA (and the system may automatically suggest an alternate design to avoid that result).

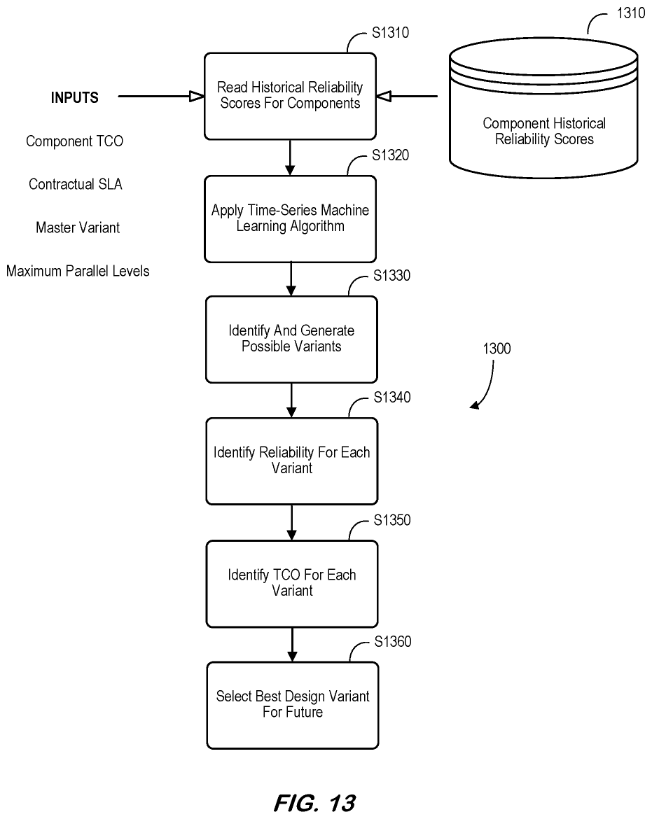

In addition to continuously monitoring performance in substantially real time, some embodiments may use machine learning to evaluate future design performance. For example, FIG. 13 is a machine learning process flow 1300 to predict a future design in accordance with some embodiments. The flow 1300 uses a machine learning model to predict potential reliability changes that might happen in the future (and forecast the best design to adjust for such reliability changes). This may help an enterprise understand future changes via time-series based models (which use component historical reliability scores 1310) and prepare accordingly. Such a pro-active approach may let an organization act based on the potential future changes to save effort and time.

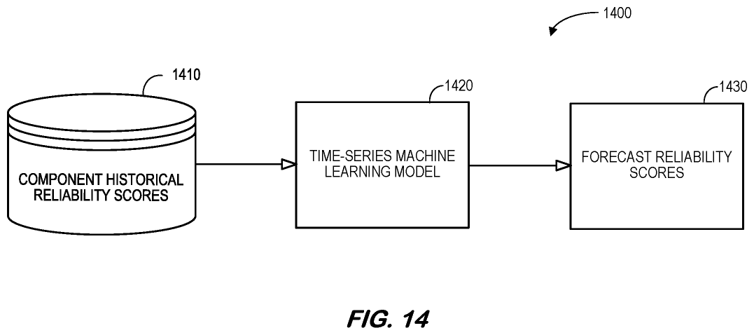

Initially, the historical reliability scores for the components are stored for future use. At S1310, the system reads the data from the storage and passes it to a machine learning model for processing. The system may also receive relevant inputs, such as component TCO, a contractual SLA, a master variant design, a maximum number of parallel levels, etc. At S1320, the time-series machine learning model (or models) are applied to predict future reliability changes for design components. For example, the system may read the component historical reliability scores 1310 and apply the time-series based machine learning algorithm (e.g., autoregressive, exponential smoothing, the prophet library, etc.) to forecast potential reliability changes for components. For example, FIG. 14 is a high-level machine learning system architecture 1400 according to some embodiments. Component historical reliability scores 1410 are provided to a time series machine learning model 1420 which then generates forecast reliability scores 1430. Referring again to FIG. 13, the system may then use the forecast component reliability scores to identify and generate possible variants at S1330, identify future reliability for each variant at S1340, and identify the TCO for each variant at S1350. In this way, the best scenario variant for the future may be selected at S1360 and suggested to a service provider or customer. This may help a user understand the best future designs.

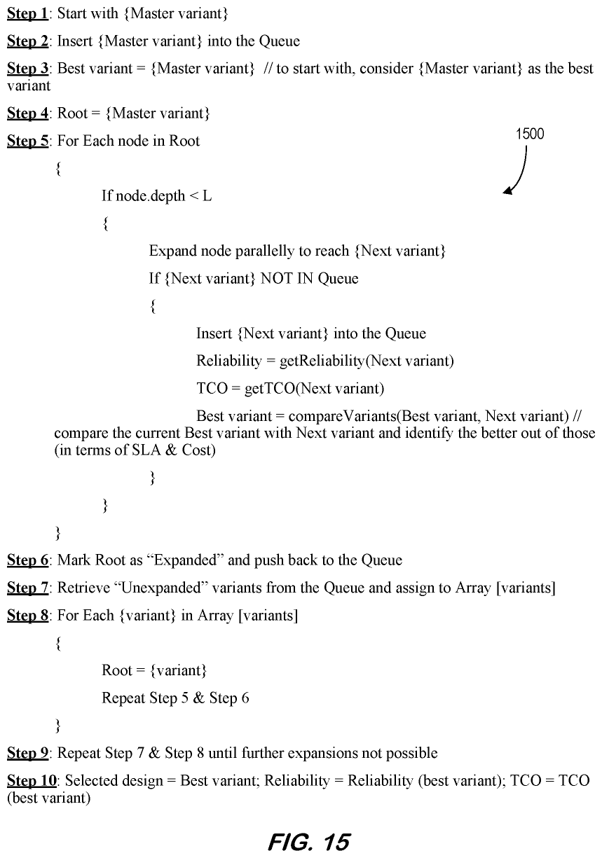

FIG. 15 is an overall evaluation process 1500 in accordance with some embodiments. The process 1500 may receive {Master Variant} as an input (defining nodes arranged in a sequential order without parallel expansion). Other inputs may include a maximum number of possible expansion levels (L) defining a number of connections and/or back-up components and a contractual SLA with a customer. Additional inputs may include NodeReliability defining a calculated reliability of each node (based on failures and MTBF) to measure each variant's reliability (by applying series and parallel reliability formulas) and NodeTCO reflecting a total cost of each component.

Step 1 starts with {Master Variant} which is inserted to a queue at Step 2. At Step 3, the best variant is defined to be {Master Variant} and Steps 4 and 5 expand the node in a parallel fashion to reach {Next Variant}. Variants are compared in terms of SLA and cost to select the best variant. Step 6 marks the root as “Expanded” and places it back into the queue. Steps 7 through 9 continue until no further expansions are possible. At Step 10, the best design is selected based on the best variant, reliability is set to the reliability of the best variant, and the TCO is set to the TCO of the best variant.

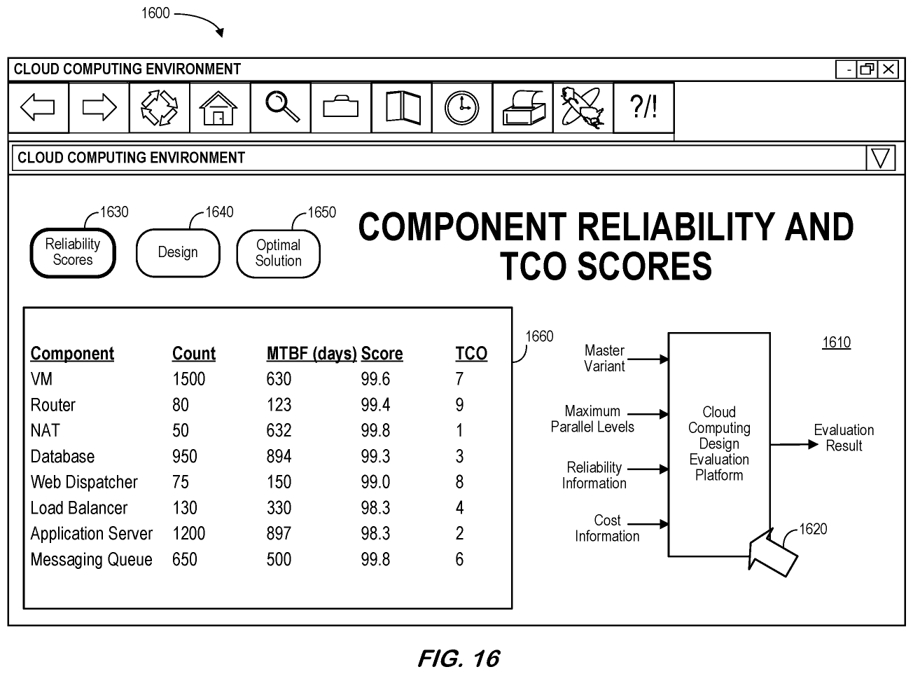

Some embodiments may provide user interfaces to facilitate execution of an algorithm for a reliable, cost-optimal system design. For example, FIG. 16 is a reliability score display 1600 according to some embodiments. The display 1600 includes a graphical representation 1610 or dashboard that might be used to manage or monitor a design evaluation framework (e.g., associated with a cloud provider). In particular, selection of an element (e.g., via a touchscreen or computer mouse pointer 1620) might result in the display of a popup window that contains mapping or configuration data. The display 1600 may also include a user selectable “reliability scores” icon 1630, a “design” icon 1640, and an “optimal solution” icon 1650 to provide user navigation (e.g., to investigate or improve a system design, change a field mapping parameter, etc.). The display 1600 also includes a component reliability table 1660 containing, for each component, an overall component count, a MTBF (in days), a component reliability score, and component TCO information.

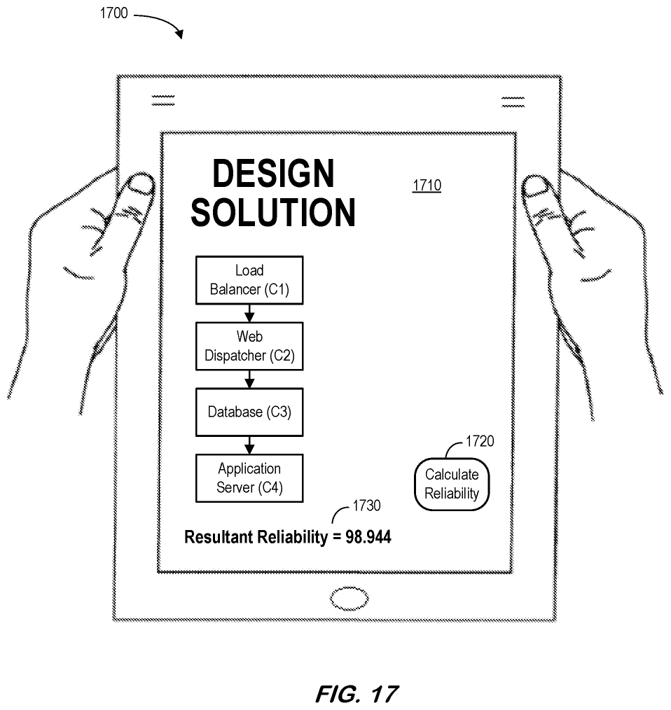

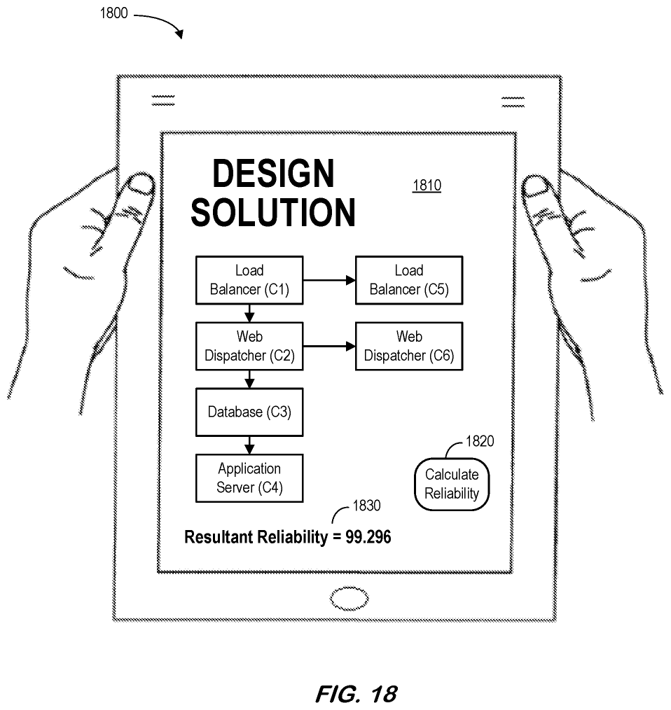

Other user interfaces may help develop a system solution by connecting components (in serial parallel fashion). For example, FIG. 17 is a tablet computer 1700 providing a design solution display 1710 in accordance with some embodiments. The display 1710 lets a user arrange a sequential series of components (e.g., a load balancer (C1), a web dispatcher (C2), etc.) and request that the system calculate an overall reliability score for the design via icon 1720. When requested, the score is calculated and displayed 1730. Note that it is possible to increase the overall system reliability by adding parallel components. For example, FIG. 18 is a tablet computer 1800 showing another design solution display 1810 according to some embodiments. In this case, a parallel load balancer (C5) and web dispatcher (C6) have been added to the system design. As a result, when the user asks the system to again calculate reliability via icon 1820, the improved score 1830 is shown (as compared to the score 1730 of FIG. 17).

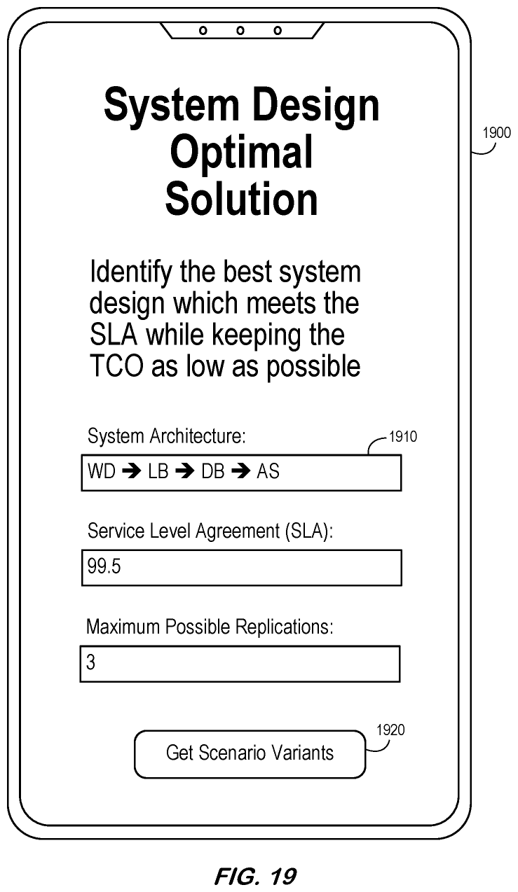

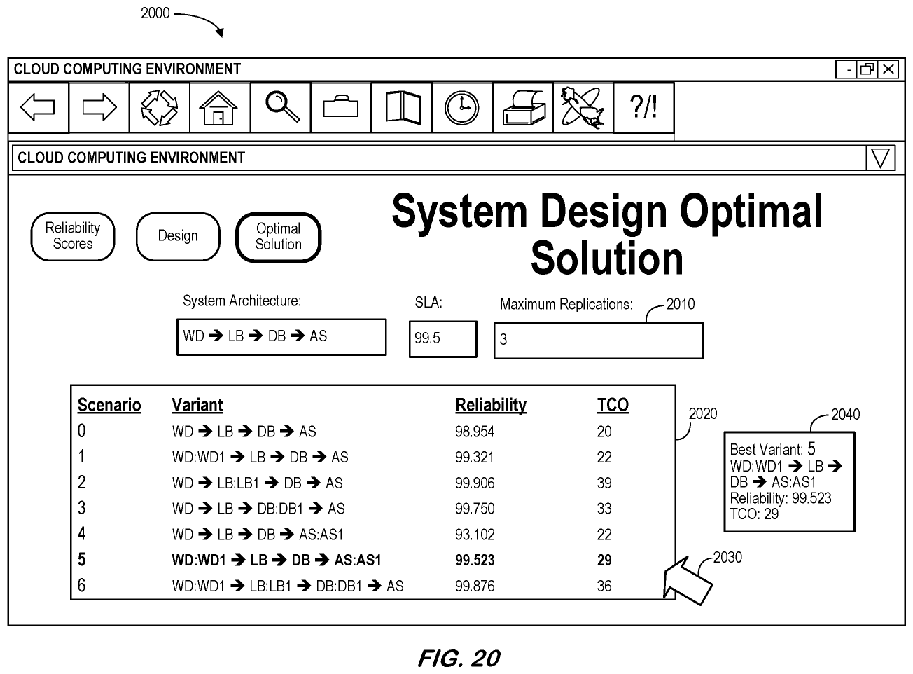

The user interface may help generate all possible design variants for a set of given inputs. FIG. 19 is a smartphone optimal solution user interface 1900 in accordance with some embodiments. The interface may be used to define a system architecture, SLA, a maximum number of allowable replications, etc. via data entry fields 1910. When the user activates a “Get Scenario Variants” icon 1920 the system may use those inputs to generate variants. For example, FIG. 20 is an evaluation result display 2000 according to some embodiments. The display 2000 includes, for a given set of inputs 2010, a table 2020 showing a list of possible variants. For each variant, the table 2020 contains a scenario identifier, a variant definition, a reliability score, and a TCO. Selection of a variant (e.g., via a touchscreen or computer pointer 2030) may let a user “drill down” to see more detailed information about that variant. The display 2000 also includes an automatically selected “optimal solution” 2040 in view of the inputs 2010.

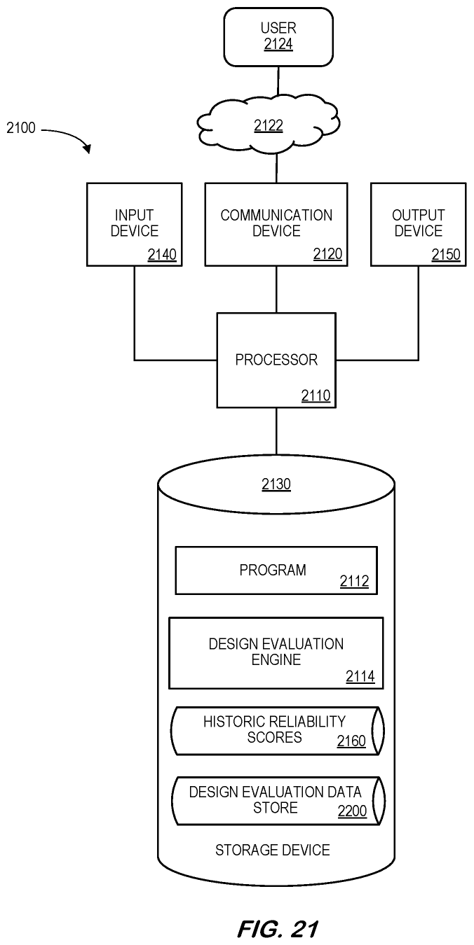

Note that the embodiments described herein may be implemented using any number of different hardware configurations. For example, FIG. 21 is a block diagram of an apparatus or platform 2100 that may be, for example, associated with the system 100 of FIG. 1 (and/or any other system described herein). The platform 2100 comprises a processor 2110, such as one or more commercially available CPUs in the form of one-chip microprocessors, coupled to a communication device 2120 configured to communicate with a user 2124 via a communication network 2122. The platform 2100 further includes an input device 2140 (e.g., a computer mouse and/or keyboard to input data about a master variant, component reliability, component TCO, etc.) and an output device 2150 (e.g., a computer monitor to render a display, to transmit results, recommendations, and/or alerts, to create monitoring or prediction reports, etc.). According to some embodiments, a mobile device and/or PC may be used to exchange data with the platform 2100.

The processor 2110 also communicates with a storage device 2130. The storage device 2130 can be implemented as a single database, or the different components of the storage device 2130 can be distributed using multiple databases (that is, different deployment data storage options are possible). The storage device 2130 may comprise any appropriate data storage device, including combinations of magnetic storage devices (e.g., a hard disk drive), optical storage devices, mobile telephones, and/or semiconductor memory devices. The storage device 2130 stores a program 2112 and/or design evaluation engine 2114 for controlling the processor 2110. The processor 2110 performs instructions of the programs 2112, 2114, and thereby operates in accordance with any of the embodiments described herein. For example, the processor 2110 may receive a master variant for a cloud computing design, including a sequential sequence of a set of components. The processor 2110 may then determine a maximum number of parallel levels for the master variant and automatically create a plurality of potential variants of the master variant by expanding the master variant with parallel components in accordance with the maximum number of parallel levels. The processor 2110 determines reliability information (e.g., MTBF) and cost information (e.g., TCO) for each of the set of components. An overall reliability score and overall cost score for each of the automatically created potential variants is automatically calculated by the processor 2110, and an evaluation result of the calculation is indicated.

The programs 2112, 2114 may be stored in a compressed, uncompiled and/or encrypted format. The programs 2112, 2114 may furthermore include other program elements, such as an operating system, clipboard application, a database management system, and/or device drivers used by the processor 2110 to interface with peripheral devices.

As used herein, data may be “received” by or “transmitted” to, for example: (i) the platform 2100 from another device; or (ii) a software application or module within the platform 2100 from another software application, module, or any other source.

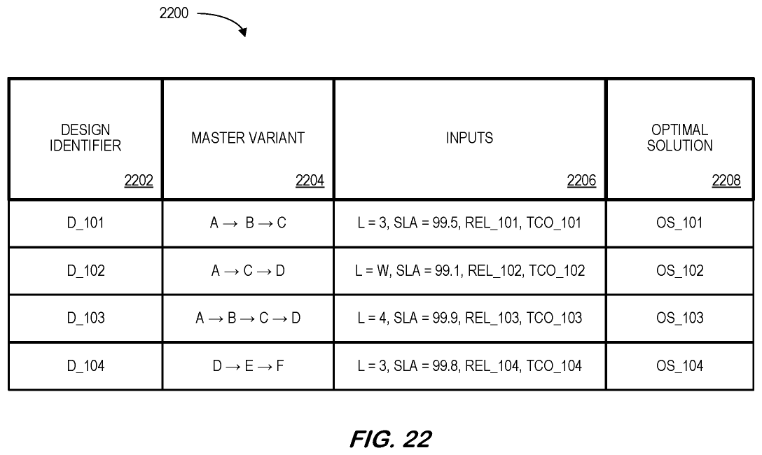

In some embodiments (such as the one shown in FIG. 21), the storage device 2130 further stores historic reliability scores 2160 and a design evaluation data store 2200. An example of a database that may be used in connection with the platform 2100 will now be described in detail with respect to FIG. 22. Note that the database described herein is only one example, and additional and/or different data may be stored therein. Moreover, various databases might be split or combined in accordance with any of the embodiments described herein.

Referring to FIG. 22, a table is shown that represents the design evaluation data store 2200 that may be stored at the platform 2100 according to some embodiments. The table may include, for example, entries identifying system designs being evaluated in connection with a cloud computing environment. The table may also define fields 2202, 2204, 2206, 2208 for each of the entries. The fields 2202, 2204, 2206, 2208 may, according to some embodiments, specify: a design identifier 2202, a master variant 2204, inputs 2206, and an optimal solution 2208. The design evaluation data store 2200 may be created and updated, for example, when a new component is added, a contractual SLA is updated, etc.

The design identifier 2202 might be a unique alphanumeric label or link that is associated with a cloud-based system design being evaluation, monitored, predicted, etc. The master variant 2204 may comprise a series of components defining how the design operates. The inputs 2206 may include a maximum number of parallel levels (L), a SLA, reliability information, TCO information, etc. The optimal solution 2208 may comprise a design that has been selected, from a set of potential variants to the master variant 2204, as the best design in view of the inputs 2206.

Thus, embodiments may help identify the components that require high availability (along with the number of instances) in order to maintain a SLA while keeping the TCO as low as possible. Embodiments may provide a scientific model to a service provider to help them understand which of the components require replication (and how many instances). Some embodiments continuously monitor the designs and generate alerts if the total reliability drops below the SLA. If so, the system may regenerate the design variants and suggest a new best variant to meet the SLA. Some embodiments apply a machine learning model to forecast reliability changes and predict the future best scenario based on the predicted changes. Moreover, embodiments may let a service provider offer different packages to different customers based on SLA requirements (making the contractual SLAs dynamic in nature).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications with modifications and alterations limited only by the spirit and scope of the appended claims.

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of enterprise and system components and designs, any of the embodiments described herein could be applied to other types of components and designs. Moreover, the displays shown herein are provided only as examples, and any other type of user interface could be implemented.

What is claimed is:

1. A system, comprising:
a cloud computing design evaluation platform, including:
a computer processor, and
a computer memory coupled to the computer processor and storing instructions that, when executed by the computer processor, cause the cloud computing design evaluation platform to:
receive a master variant for a cloud computing design, including a sequential sequence of a set of components,
determine a maximum number of parallel levels for the master variant,
automatically create a plurality of potential variants of the master variant by expanding the master variant with parallel components in accordance with the maximum number of parallel levels,
determine reliability information for each of the set of components,
determine cost information for each of the set of components,
automatically calculate an overall reliability score and overall cost score for each of the automatically created potential variants, and
indicate an evaluation result of said calculation.

2. The system of claim 1, wherein evaluation result represents an optimum design that meets a Service Level Agreement (“SLA”) while keeping an associated Total Cost o of Ownership (“TCO”) to a minimum.

3. The system of claim 1, wherein at least one of the components is associated with at least one of: (i) a load balancer, (ii) a dispatcher, (iii) a database, (iv) an application server, (v) a file system, (vi) a router, (vii) memory, (viii) Network Address Translation (“NAT”), and (ix) a messaging queue.

4. The system of claim 1, wherein the reliability information is associated with a Mean Time Between Failure (“MTBF”) for each component.

5. The system of claim 4, wherein the cost information is associated with a Total Cost of Ownership (“TCO”) for each component.

6. The system of claim 5, wherein potential variants of the master variant are created by expanding the master variant with parallel identical components.

7. The system of claim 5, wherein at least one potential variant of the master variant is created by expanding the master variant with a parallel alternate component.

8. The system of claim 5, wherein the cloud computing design evaluation platform is further to determine a Service Level Agreement (“SLA”) associated with the cloud computing design and the evaluation result comprises a selection of one of the automatically created potential variants based on the SLA, the overall reliability scores, and the overall cost scores.

9. The system of claim 5, wherein the cloud computing design evaluation platform continuously monitors the cloud computing design in real time based on design performance.

10. The system of claim 5, wherein the cloud computing design evaluation platform uses a machine learning model to predict future cloud computing design performance based on historical cloud computing design performance.

11. The system of claim 10, wherein the cloud computing design evaluation platform automatically generates a recommended design based on the predicted future cloud computing design performance.

12. The system of claim 1, wherein at least one of the sequential sequence of a set of components, the maximum number of parallel levels, the reliability information, and the cost information is received via an interactive graphical user interface.

13. A method, comprising:
receiving, by a computer processor of a cloud computing design evaluation platform, a master variant for a cloud computing design, including a sequential sequence of a set of components;
determining a maximum number of parallel levels for the master variant;
automatically creating a plurality of potential variants of the master variant by expanding the master variant with parallel components in accordance with the maximum number of parallel levels;
determining reliability information for each of the set of components;
determining cost information for each of the set of components;
automatically calculating an overall reliability score and overall cost score for each of the automatically created potential variants; and
indicating an evaluation result of said calculation.

14. The method of claim 13, wherein the reliability information is associated with a Mean Time Between Failure (“MTBF”) for each component.

15. The method of claim 14, wherein the cost information is associated with a Total Cost of Ownership (“TCO”) for each component.

16. The method of claim 15, wherein potential variants of the master variant are created via at least one of: (i) expanding the master variant with parallel identical components, and (ii) expanding the master variant with a parallel alternate component.

17. The method of claim 15, wherein the cloud computing design evaluation platform is further to determine a Service Level Agreement (“SLA”) associated with the cloud computing design and the evaluation result comprises a selection of one of the automatically created potential variants based on the SLA, the overall reliability scores, and the overall cost scores.

18. A non-transitory, machine-readable medium comprising instructions thereon that, when executed by a processor, cause the processor to execute operations to perform a method, the method comprising:
receiving, by a computer processor of a cloud computing design evaluation platform, a master variant for a cloud computing design, including a sequential sequence of a set of components;
determining a maximum number of parallel levels for the master variant;
automatically creating a plurality of potential variants of the master variant by expanding the master variant with parallel components in accordance with the maximum number of parallel levels;
determining reliability information for each of the set of components;
determining cost information for each of the set of components;
automatically calculating an overall reliability score and overall cost score for each of the automatically created potential variants; and
indicating an evaluation result of said calculation.

19. The medium of claim 18, wherein the cloud computing design evaluation platform continuously monitors the cloud computing design in real time based on design performance.

20. The medium of claim 18, wherein the cloud computing design evaluation platform uses a machine learning model to predict future cloud computing design performance based on historical cloud computing design performance.

21. The medium of claim 20, wherein the cloud computing design evaluation platform automatically generates a recommended design based on the predicted future cloud computing design performance.
